(19) United States
(12) Patent Application Publication
(10) Pub. No.: US 2016/0332428 A1
(43) Pub. Date: Nov. 17, 2016

(54) NONWOVEN COMPOSITE COMPOSITIONS WITH GRAPHENE

(71) Applicant: COVERALLSPORTS, LLC, Naples, FL (US)

(72) Inventors: Anthony Salce, Naples, FL (US); William F. Greenwood, Fairfield, CT (US)

(73) Assignee: COVERALLSPORTS, LLC, Naples, FL (US)

(21) Appl. No.: 15/151,851

(22) Filed: May 11, 2016

Related U.S. Application Data
(60) Provisional application No. 62/159,716, filed on May 11, 2015.

(51) Int. Cl. B32B 27/12; C08J 5/18; B32B 27/08; B32B 27/18; B32B 5/02; B32B 5/26

(52) U.S. Cl. CPC B32B 27/12; B32B 5/022; B32B 5/26; B32B 27/08; B32B 27/18; C08J 5/18; B32B 2255/02; B32B 2255/10; B32B 2255/26; B32B 2307/724; B32B 2437/00; C08J 2300/00

(57) ABSTRACT

In one aspect, a composite composition may include a nonwoven composite material. The nonwoven composite material may include a graphene component and a polymer component. The graphene component and polymer component may form a microporous film or nonwoven fabric. In a further aspect, the composite composition may include a layered composition wherein one or more layers include the nonwoven composite material. The nonwoven composite material may also be provided as a coating or adhesive.

### CROSS-REFERENCE TO RELATED APPLICATIONS

This application claims the benefit of U.S. Provisional Patent Application 62/159,716, filed May 11, 2015, the disclosure of which is hereby incorporated by reference herein, in its entirety.

### TECHNOLOGY

The present disclosure relates to nonwoven composite materials. More specifically, the present disclosure relates to nonwoven composite materials comprising graphene.

### BACKGROUND

Nonwoven materials, such as nonwoven fabrics and films, are highly adaptable materials with numerous applications. Various nonwoven materials may be produced to provide various levels of desirable properties such as breathability, durability, absorbency, or filtration. Nonwoven materials are often used to produce articles such as garments. As an example, disposable or single use garments used in healthcare fields may be fabricated from various nonwoven materials. Some nonwoven materials may be recyclable after use, thereby reducing waste due to single or limited use aspects of the articles in which they are incorporated. Nonwoven materials used to produce garments and other articles may be made from polymer melts that may be formed into films or fiberized into webs and bound to form nonwoven fabrics.

### SUMMARY

A composite composition may include a nonwoven composite material. The nonwoven composite material may comprise a graphene component and a polymer component. In one example, the nonwoven composite material may be or include a microporous film comprising the graphene component and the polymer component. The film may be a microporous film. In one example, the composite composition may be a layered composition comprising the microporous film and a nonwoven fabric. The nonwoven fabric may be laminated with the microporous film. In one example, the nonwoven composite material may comprise a nonwoven fabric comprising the graphene component and the polymer component. The graphene component and the polymer component may be a binder. The binder may be a finishing binder. The polymer component may include a thermoplastic or resin. In one example, the composite composition comprises a nonwoven fabric, wherein the nonwoven composite material coats the nonwoven fabric.

In one example, the composite composition comprises a layered composition comprising a nonwoven fabric layer and a microporous film layer, wherein at least one of the nonwoven fabric layer or microporous film layer is coated with the nonwoven composite material.

In one example, the composite composition comprises a layered composition, wherein the nonwoven composite material comprises an adhesive laminating a first layer and a second layer of the layered composition. The first layer may comprise a nonwoven fabric layer and the second layer comprise a microporous film layer. The layered composition may include a third layer comprising a nonwoven fabric or microporous film. The third layer may be thermally bonded or laminated with the first or second layer. The nonwoven composite material comprises an adhesive to laminate the third layer with the first or second layer. In one example, the nonwoven composite material may laminate or coat the third layer.

In one example, the nonwoven composite material comprises a first layer of a layered composition. The nonwoven composite material of the first layer may comprise a microporous film and the microporous film may be thermally bonded to a second layer comprising a nonwoven fabric. In one example of a layered composition, the nonwoven composite material of the first layer comprises a microporous film and the microporous film may be thermally bonded to a second layer comprising a microporous film. The composite composition may comprise a third layer. The third layer may be thermally bonded to one of the first or second layers. The third layer may comprise a nonwoven fabric or a microporous film. In one example, the third layer comprises a nonwoven fabric or a microporous film that is thermally bonded to one of the first or second layers.

In one example of a layered composition, the nonwoven composite material of the first layer comprises a nonwoven fabric, and the nonwoven fabric may be thermally bonded to a second layer comprising a microporous film A third layer may be thermally bonded to one of the first or second layers, and the third layer may comprise a nonwoven fabric or a microporous film. In one example of a layered composition, the nonwoven composite material of the first layer comprises a nonwoven fabric, and the nonwoven fabric may be thermally bonded to a second layer comprising a nonwoven fabric. A third layer may be thermally bonded to one of the first or second layers, and the third layer may comprise a nonwoven fabric or a microporous film.

### BRIEF DESCRIPTION OF THE FIGURES

The novel features of the described embodiments are set forth with particularity in the appended claims. The described embodiments, however, both as to organization and manner of operation, may be best understood by reference to the following description, taken in conjunction with the accompanying drawings in which:

FIG. 1 illustrates a composite composition according to various embodiments described herein;

FIG. 2 illustrates a composite composition according to various embodiments described herein;

FIG. 3A illustrates a composite composition according to various embodiments described herein;

FIG. 3B illustrates a composite composition according to various embodiments described herein;

FIG. 4 illustrates a composite composition according to various embodiments described herein;

FIG. 5 illustrates a composite composition according to various embodiments described herein;

FIG. 6 illustrates a composite composition according to various embodiments described herein; and

FIG. 7 illustrates a composite composition according to various embodiments described herein.

### DESCRIPTION

Described herein are composite compositions including a graphene additive stably associated therein. The graphene additive may provide increased rigidity to a breathable composite composition. For example, the additive may provide increased rigidity or tensile strength to the composite composition. The graphene additive may also enhance or provide, alone or together with other components, the composite composition with one or more additional properties such as liquid barrier characteristics, thermal barrier characteristics, fire retardant, electrostatic dissipation, or other desirable properties.

In various embodiments, the composite composition comprises a nonwoven composite material that includes a polymer component and a graphene component. The graphene component may comprise graphene. The polymer component may comprise one or more thermoplastics, thermoset polymers, or combinations thereof. In one embodiment, the polymer component comprises one or more thermoplastics selected from polyvinyl chloride, polypropylene, polyethylene, polyactic acid, polyamide, polybenzimidazole, or combinations thereof. A polyethylene may include, for example, polyethylene or polyethylene terephthalate. In some embodiments, the polymer component may comprise or include a resin or resin that is converted to a polymer. For example, the polymer component may be a binding resin or adhesive resin. In various embodiments, the nonwoven composite material comprises the graphene component stably associated with the polymer component, or portions thereof. For example, the graphene component may be dispersed, integrated, incorporated, encapsulated, bound, retained, or otherwise located within a web, e.g., sheet, matrix, or film, that includes the polymer component, or portions thereof. The graphene component may be added to the polymer component during fabrication of the nonwoven composite material. In various embodiments, the graphene component and the polymer component may be in the form of a polymer-graphene dispersion, mixture, powder, solution, solvent, or other suitable form. The graphene component and the polymer component may be used to fabricate a film, nonwoven fabric, or combination thereof. The graphene component and the polymer component may be used as a coating, binder, or laminate adhesive in the fabrication of a woven, nonwoven, or combination woven and nonwoven material, including such materials in a layered arrangement. The graphene component and the polymer component may be applied to materials by spraying, spreading, coating, laminate, extrusion, finishing layer or coating, etc. The graphene component may provide additional rigidity, including tensile strength. The graphene component may also provide a fire retardant barrier to the nonwoven composite material, which may include materials to which the nonwoven composite material may be applied or layered. The graphene component may provide additional properties to the nonwoven composite material such as thermal conductivity, chemical and biological resistance, and electrostatic dissipation. The graphene component may also provide a conductive coating to the nonwoven composite, such as for a garment formed from the composite composition, with a need for an additional thermal barrier. In various embodiments, the composite composition may be formed only of the nonwoven composite material or may include additional materials, e.g., layers or components, as described herein. When the composite composition comprises a layered composition having one or more layers comprising the nonwoven composite material, the incorporation of the nonwoven composite material may impart properties of the nonwoven composite material to the layered composition. The properties of the nonwoven composite material may work together, including synergistically, with properties of additional layers.

As described in further detail below, the composite composition comprising the nonwoven composite material may take many forms. For example, in various embodiments, the nonwoven composite material comprising the graphene component and the polymer component may comprise a microporous film or a nonwoven fabric. In further examples, the composite composition may comprise a layered composition wherein the nonwoven composite material may comprise one or more layers layered with or between one or more additional layers of the composition. Additional layers may include composite or noncomposite compositions, such as woven fabrics, nonwoven fabrics, films, including microporous films, or combinations thereof. In one embodiment, the composite composition comprises a layered composition wherein the nonwoven composite material comprises a binding layer or adhesive layer, e.g., of a laminate, positioned between layers of composite compositions, noncomposite compositions, or both, which may include woven fabrics, nonwoven fabrics, films, including microporous films, or combinations thereof. In some embodiments, the composite composition comprises a coated composition wherein the nonwoven composite material comprises a coating applied to a composite or noncomposite composition, which may include a woven fabric, nonwoven fabric, film, including a microporous film, or combinations thereof.

Films with Graphene Additive

In various embodiments, the nonwoven composite material of the composite composition comprises a film into which the graphene component is stably associated with the polymer component. For example, the graphene component may be dispersed, integrated, incorporated, encapsulated, bound, retained, or otherwise located within a web, e.g., sheet, matrix, or film, that includes the polymer component. In one embodiment, the film may be filled or infused with the graphene component.

The association of the graphene component and polymer component may provide properties to the film such as rigidity, e.g., which may include tensile strength, liquid barrier characteristics, fire retardant, electrostatic dissipation, or other properties.

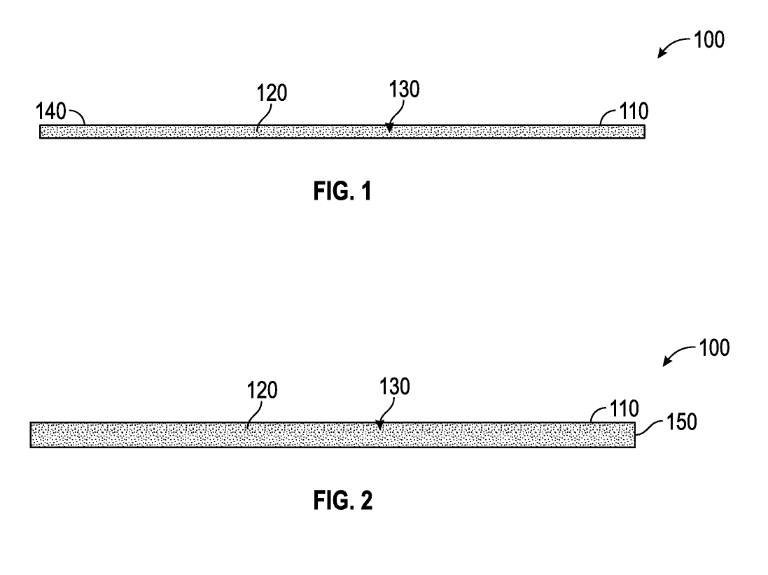

FIG. 1 illustrates an embodiment of a composite composition 100 comprising a nonwoven composite material 110. The nonwoven composite material 110 includes a graphene component 120 and a polymer component 130 fabricated in the form of a microporous film 140 fabricated to include a structure that may enable vapors to flow through the film while blocking liquids from penetrating.

The polymer component 130 may comprise one or more thermoplastics, thermoset polymers, or combinations thereof. In some embodiments, the polymer component 130 comprises at least one synthetic resin. In one example, the polymer component 130 comprises at least one polyolefin, a blend comprising at least two polyolefins, or a blend comprising a polyolefin and at least one nonpolyolefin. In one of the above or another example, the polymer component 130 comprises an epoxy resin. In one embodiment, the polymer component 130 comprises one or more thermoplastics selected from polyvinyl chloride, polypropylene, polyethylene, polyactic acid, polyamide, polybenzimidazole, or combinations thereof.

In various embodiments, the microporous film 140 may comprise between 1% and 25%, 1% and 20%, 1% and 15%, 1% and 10%, 5% and 25%, 5% and 20%, 5% and 15%, 5% and 10%, 10% and 25%, 10% and 20%, 10% and 15%, 15% and 25%, 15% and 20%, or 20% and 25% graphene by weight. In some embodiments, the microporous film 140 comprises at least 5% and less than about 25%, about 20%, about 15%, about 12%, about 10%, or about 8% by weight graphene. In some embodiments, larger amounts of graphene by weight may be used, which may further enhance the properties provided by the graphene. For example greater than 25%, greater than 30%, greater than 35%, greater than 40%, greater than 45%, greater than 50%, greater than 60%, greater than 70%, greater than 80%, or greater than 90%. Such larger amounts of graphene may find particular application, for example, to fabricate darker color fabrics. All or a portion of the remaining weight may be provided by the polymer component 130. In certain embodiments, the microporous film 140 comprises at least about 20%, about 30%, about 40%, about 50%, about 55%, about 60%, about 65%, about 70%, about 75%, about 80%, about 85%, about 90%, about 95%, or about 99% polymer component 130 by weight. When larger amounts of graphene component 120 are used, the amount of polymer component 130 is The microporous film 140 may also include additional components such as fillers. In some embodiments, the microporous film 140 may include between 3% and 25%, 4% and 20%, 4% and 15%, 4% and 10%, 5% and 15%, or between 7% and 15% filler by weight.

The microporous film 140 may be fabricated by any suitable method. In various embodiments, the microporous film 140 is fabricated, at least in part, from a melt. The melt may include all or a portion of the polymer component 130. The melt may also include all or a portion of the graphene component 120. In one example, the graphene component 120 includes graphene additive within the melt. In a further example, the graphene component 120 includes graphene additive added to the melt during fabrication or that is heated together with all or a portion of the polymer component 130 to form the melt. The graphene component 120 comprising graphene may be provided into the melt in any suitable format. In one embodiment, the graphene component may be provided into the fabrication process in the form of a nanopowder, pellets, an oxide dispersion, combination thereof, or other suitable format. In at least one embodiment, the nanopowder, pellets, oxide dispersion, combination thereof, or other suitable format comprises at least a portion of the polymer component 130.

In one embodiment, fabrication of the microporous film 140 comprises forming a precursor composite film from the melt. The precursor composite film may be stretched to form micropores or micropore networks (not shown). For example, stretching the precursor composite film may interconnect micropores to form pathways through the film. In some embodiments, the melt further includes a filler material. In such embodiments, the precursor composite formed from the melt may therefore include the filler material dispersed therein. The filler material may be an inorganic filler material dimensioned and provided in an amount configured to aid in the formation of the micropores and the interconnection thereof during stretching. Examples of inorganic filler material may include pulp, titanium dioxide, or calcium carbonate. In various embodiments, the melt or precursor composite film may include between 3% and 25%, 4% and 20%, 4% and 15%, 5% and 15%, or between 7% and 15% inorganic filler by weight. Stretching may be performed by any suitable method. For example, stretching may include mechanical stretching of the precursor composite film between rollers. Stretching may include biaxial, uniaxial, biaxial, or multiaxial stretching, e.g., machine direction, oblique, cross, or any combination thereof.

The resulting microporous film 140 may contain millions of micropores many of which may interconnect to provide size limited paths through the film. A pore size diameter of a pore in the microporous film 140 may be smaller than a drop of water, such that a water droplet, for example a rain drop, may not penetrate the microporous film 140 unless extraordinary pressure is applied. The size of the pores formed in the microporous film 140 may be chosen based on the size and distribution of the particles to be filtered or blocked by the nonwoven composite material 110 or microporous film 140 in order to prevent penetration of such particles through the nonwoven composite material 110 or microporous film 140. For example, the average pore size (diameter) may be less than about 100 um, less than about 50 urn, less than about 10 um, less than about 1 urn, less than about 500 nm, less than about 250 nm, less than about 100 nm, less than about 50 nm, or less than about 10 nm.

Incorporation of the graphene component 120 in the microporous film 140 may enhance rigidity or tensile strength in a breathable film having one or more properties selected from liquid barrier, fire retardant, and electrostatic dissipation. In some embodiments, the microporous film 140 may be generally opaque even when the microporous film 140 is made of from transparent material. The composite composition 100 may include composites of various colors, e.g., white, orange, blue, green, red, yellow, florescent orange, florescent yellow, etc. and weight compositions. To obtain desired colors, dyes may be added during fabrication, e.g., to the melt, or after fabrication. In some embodiments, the microporous film 140 is not dyed. Fabricating a composite composition 100 having desired colors may include forming a layered composition 160 wherein the microporous film 140 is layered with a woven or nonwoven fabric having a desired color or color combination.

In various embodiments, the composite composition 100 may comprise a woven or nonwoven fabric wherein the microporous film 140 or the precursor composite film is layered, laminated, or otherwise adhered or bonded to the woven or nonwoven fabric 150. For example, the microporous film 140 or precursor composite film may coat, e.g., by extrusion coating, the woven or nonwoven fabric 150. In another example, the microporous film 140 may be thermally or ultrasonically bonded to the woven or nonwoven fabric 150. In one embodiment, the composite composition 100 comprises a multilayered composition 160 wherein the microporous film 140 or precursor composite film is co-extruded with at least a second microporous film 140 or precursor composite film. The second microporous film 140 or precursor composite film may include a second polymer component 130. The second polymer component 130 may comprise a same or different polymer or polymer blend than the polymer component 130 of the nonwoven composite material 110. In various embodiments, the second polymer component 130 comprises one or more thermoplastics, thermoset polymers, or combinations thereof. In some embodiments, the second polymer component 130 comprises at least one synthetic resin. In one example, the second polymer component 130 comprises at least one polyolefin, a blend comprising at least two polyolefins, or a blend comprising a polyolefin and at least one nonpolyolefin. In one of the above or another example, the second polymer component 130 comprises an epoxy resin. In one embodiment, the second polymer component 130 comprises one or more thermoplastics selected from a polyvinyl chloride, polypropylene, polyethylene, polyactic acid, polyamide, polybenzimidazole, or combinations thereof.

Nonwoven Fabrics with Graphene Additive

FIG. 2 illustrates an embodiment of a composite composition 100 comprising a nonwoven composite material 110. The nonwoven composite material 110 includes a graphene component 120 and a polymer component 130 fabricated in the form of a nonwoven fabric 150 in which the graphene component 120 is stably associated with the polymer component 130 or portion thereof. For example, the graphene component 120 may be dispersed, integrated, incorporated, encapsulated, bound, retained, or otherwise located within a web, e.g., sheet or matrix, that includes the polymer component 130.

The nonwoven composite material 110 may be fabricated by any suitable method. In one embodiment, the nonwoven composite is fabricated from a melt comprising the polymer component 130, or portion thereof, and the graphene component 120, or portion thereof. In one example, the graphene component 120 comprises an additive within the melt. In a further example, the graphene component 120, or portion thereof, may be added to the melt during fabrication or may be heated together with the polymer component 130 to form the melt. The graphene component 120 may be provided in the form of a nanopowder, pellets, or an oxide dispersion, or any combination thereof. In at least one embodiment, the nanopowder, pellets, or oxide dispersion comprises at least a portion of the polymer component 130. The polymer component 130 may comprise one or more thermoplastics, thermoset polymers, or combinations thereof. In some embodiments, the polymer comprises at least one synthetic resin. In one example, the polymer component 130 comprises at least one polyolefin, a blend comprising at least two polyolefins, or a blend comprising a polyolefin and at least one nonpolyolefin. In one of the above or another example, the polymer component 130 comprises an epoxy resin. In one embodiment, the polymer component 130 comprises at least one thermoplastic selected from a polyvinyl chloride, polypropylene, polyethylene, polyactic acid, polyamide, polybenzimidazole, or combinations thereof.

In various embodiments, the nonwoven fabric 150 may comprise between 1% and 25%, 1% and 20%, 1% and 15%, 1% and 10%, 5% and 25%, 5% and 20%, 5% and 15%, 5% and 10%, 10% and 25%, 10% and 20%, 10% and 15%, 15% and 25%, 15% and 20%, or 20% and 25% graphene by weight. In some embodiments, the nonwoven fabric 150 comprises at least 5% and less than about 25%, about 20%, about 15%, about 12%, about 10%, or about 8% by weight graphene. In some embodiments, larger amounts of graphene by weight may be used, which may further enhance the properties provided by the graphene. For example greater than 25%, greater than 30%, greater than 35%, greater than 40%, greater than 45%, greater than 50%, greater than 60%, greater than 70%, greater than 80%, or greater than 90%. Such larger amounts of graphene may find particular application, for example, to fabricate darker color fabrics. All or a portion of the remaining weight may be provided by the polymer component 130. In various embodiments, the nonwoven fabric 150 may comprise at least about 20%, about 30%, about 40%, about 50%, about 55%, about 60%, about 65%, about 70%, about 75%, about 80%, about 85%, about 90%, about 95%, or about 99% polymer component 130 by weight. In one embodiment, fabrication of the nonwoven fabric 150 comprises fiberizing the polymer component 130 together with graphene component 120 to form a web. For example, the graphene component 120 may be within a melt that includes the polymer component 130, which may then be fiberized to form the web. In some embodiments, the nonwoven fabric 150 may be prepared by an extrusion process. For example, fiberizing may include extruding the melt. The graphene component 120 and polymer component 130, which may be fiberized in whole or in part, may be wetlaid, airlaid, spunlaid, meltblown, spunbond, spunbond-meltblown, hydroentangled or spunlace, for example, to form a web. During processing, the fibers or web may be stretched or calendared on rolls. It will be appreciated that staple-fiber based processes may similarly be applied in various embodiments to form webs. For example, fiber preparation, e.g., opening and mixing, followed by web formation, e.g., by carding, air-lay, or wet-lay processes. Webs may also be stacked, e.g., using parallel, cross, perpendicular-lay processes. Various additional methods of fabricating nonwoven fabrics are described in Nonwoven Technology (Web), Module/Lectures, (2009-2011), National Programme on Technology Enhanced Learning (2009-2011), available at http://nptel.ac.in/courses/116102014/, the contents of which is herein incorporated by reference. In some embodiments, fabricating the nonwoven web may comprise binding the web. Binding the web may include, for example, ultrasonic bonding, thermal bonding (e.g., roller, through-air, UV, infrared), adhesives, chemical treatments, binding resins, mechanically working the material, entanglement, or combinations thereof. Various bonding processes may be used. In some embodiments, binders may be used. For example, a binder may be added to the web and heated to thermally bond the web. In some embodiments, the binder may be present with non-binder components, such as carriers and graphene component. Binder may be present between about 5% and 50% or between 5% and 95%, for example. In at least one embodiment, fabrication of the nonwoven fabric 150 comprises adding a binder comprising all or a portion of the graphene component 120 and a binding component to the web, comprising fiberized polymer component 130, and adhering or thermally bonding the web. In one embodiment, the web includes a fiberized portion of the polymer component 130 and a portion of the graphene component 120 prior to bonding with the binder. In one embodiment, the binding component includes a portion of the polymer component 130 comprising one or more suitable binding polymers, such as a suitable binding resin. The one or more binding polymers of the polymer component 130 may be the same or different than the one or more fiberized polymers of the polymer component 130. For example, the binding resin may include a melt comprising one or more suitable binding polymers selected from thermoplastics, thermoset polymers, a synthetic resin, a polyolefin, a blend comprising at least two polyolefins, a blend comprising a polyolefin and at least one nonpolyolefin, or combinations thereof. In one embodiment, the binding resin may include a melt comprising an epoxy resin, a polyolefin, or combinations thereof. In at least one embodiment, the binding resin comprises at least one thermoplastic selected from a polyvinyl chloride, polypropylene, polyethylene, polyactic acid, polyamide, polybenzimidazole, or combinations thereof. In various embodiments, the binding resin may include percent weights of graphene component 120 and polymer component 130 similar to those described above with respect to nonwoven composite materials 110 comprising nonwoven fabrics 140.

Coated Compositions with Graphene Additive

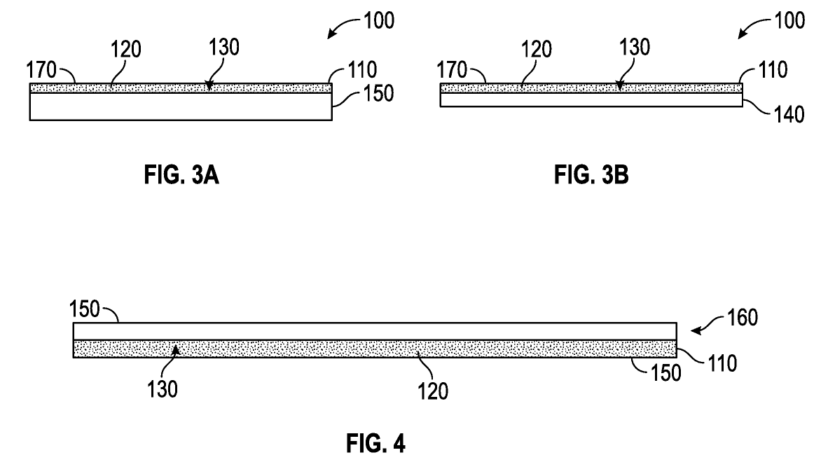

FIGS. 3A and 3B illustrate embodiments of a composite composition 100 comprising a nonwoven composite material 110. The nonwoven composite material 110 includes a graphene component 120 and a polymer component 130 fabricated in the form of a coating 170. The coating 170 may be applied to a substrate to coat a surface of the substrate. In various embodiments, the substrate may include a composite or noncomposite composition, which may include a woven fabric, nonwoven fabric 150, film, including a microporous film 140, or combinations thereof. In FIG. 3A, the substrate comprises a nonwoven fabric 150. In FIG. 3B, the substrate comprises a film, which is a microporous film 140. In other embodiments, the film may not be a microporous film 140.

The graphene component 120 may comprise graphene and be provided into the fabrication process in the form of a nanopowder, pellets, an oxide dispersion, combination thereof, or other suitable format. In at least one embodiment, the nanopowder, pellets, or oxide dispersion comprises at least a portion of the polymer component 130. The polymer component 130 of the coating may be selected from thermoplastics, thermoset polymers, a synthetic resin, a polyolefin, a blend comprising at least two polyolefins, a blend comprising a polyolefin and at least one nonpolyolefin, or combinations thereof. In one embodiment, the polymer component 130 of the coating may include an epoxy resin, a polyolefin, or combinations thereof. In at least one embodiment, the polymer component 130 of the coating comprises at least one thermoplastic selected from a polyvinyl chloride, polypropylene, polyethylene, polyactic acid, polyamide, polybenzimidazole, or combinations thereof.

In various embodiments, the coating 170 may comprise between 1% and 25%, 1% and 20%, 1% and 15%, 1% and 10%, 5% and 25%, 5% and 20%, 5% and 15%, 5% and 10%, 10% and 25%, 10% and 20%, 10% and 15%, 15% and 25%, 15% and 20%, or 20% and 25% graphene by weight. In some embodiments, the coating 170 comprises at least 5% and less than about 25%, about 20%, about 15%, about 12%, about 10%, or about 8% by weight graphene. In some embodiments, larger amounts of graphene by weight may be used, which may further enhance the properties provided by the graphene. For example greater than 25%, greater than 30%, greater than 35%, greater than 40%, greater than 45%, greater than 50%, greater than 60%, greater than 70%, greater than 80%, or greater than 90%. Such larger amounts of graphene may find particular application, for example, to fabricate darker color fabrics. All or a portion of the remaining weight may be provided by the polymer component 130. In various embodiments, the coating may comprise at least about 20%, about 30%, about 40%, about 50%, about 55%, about 60%, about 65%, about 70%, about 75%, about 80%, about 85%, about 90%, about 95%, or about 99% polymer component 130 by weight. In various embodiments, the coating 170 comprises a finishing material or may be a finishing material applied to materials of the composite composition 100. In various embodiments, the finishing material may include the polymer component 130 and the graphene component 120 in the form of a polymer-graphene dispersion, mixture, powder, or other suitable form. The finishing coating 170 may be applied as an antistatic agent, antimicrobial finish, color finish, gas barrier, lubricant, flame retardant finish, liquid barrier, stiffener, or other suitable finish. In various embodiments, a coating 170 may be applied in a single or multiple layers or coats. Prior to application, the polymer component 130 and the graphene component 120 may be in the form of a liquid, solution, dispersion, power, or other suitable form. The coating 170 may be applied by rotgravure, which may include pattern coating with rollers, rotary, extrusion, non-contact, spraying, spreading, slopping, etc. In one embodiment, nonwoven composite material 110 comprises a coating 170 wherein the graphene component 120 comprises functionalized graphene oxide, e.g., to functionalized the coated surface or enhance interactions with the polymer component 130 or substrate.

The coating may be applied in any suitable method. In one embodiment, a melt comprising the graphene component 120 and the polymer component 130 may be sprayed or blown onto the substrate. In one embodiment, the coated substrate may be stretched, as described above with respect to the nonwoven composite material 110 comprising a microporous film 140, to form micropores through the coating 170. The coating 170 may also include an inorganic filler material, which may be similar that described above with respect to the nonwoven composite material 110 comprising a microporous film 140.

The coating 170 illustrated in FIGS. 3A and 3B are applied to a single surface of the substrate. However, in other embodiments, the coating 170 may be applied at two or more surfaces or may encapsulate an inner substrate.

Layered Compositions with Graphene Additive

FIGS. 4-11 illustrate composite compositions 100 comprising layered compositions 160. In some embodiments wherein the composite composition 100 comprises a layered composition 160, the layers may be attached, e.g., bonded or adhered, at one or more locations. For example, layers may be laminated together such that the layered composition 160 comprises a laminate. Attachment may be continuous between the layers or only at distributed locations therebetween, e.g., patterned. In one example, layers may be loosely layered to provide air pockets between the layers. Layers may include any suitable layer, including those described herein. For example, layers may include composite or noncomposite materials, such as coated substrates, woven fabrics, nonwoven fabrics 150, films, including microporous films 140, or combinations thereof. In various embodiments, one or more of the layers in the embodiments illustrated in FIGS. 4-11 may be coated with a nonwoven composite material 110, e.g., a coating 170, as described above with respect to FIGS. 3A and 3B.

In various embodiments, a composite composition 100 comprises a layered composition 160 comprising at least two layers, wherein at least one of the layers comprises a nonwoven composite material 110 including a graphene component 120 and a polymer component 130. In some embodiments, the nonwoven composite material 110 comprises an adhesive or binder applied between the layers of the layered composition 160 to attach or laminate the layers. In layered compositions 160, the nonwoven composite material 110 may be in any form as described above and elsewhere herein. For example, the nonwoven composite material 110 may comprise one or more layers of the layered composition 160 in the form of a film, a microporous film 140, a nonwoven fabric 150, a binder component of a nonwoven fabric 150, a coating 170 applied to one or more layers, adhesive applied between one or more layers, other finishing applications, or combinations thereof. In various embodiments, the nonwoven composite material may comprise between 1% and 25%, 1% and 20%, 1% and 15%, 1% and 10%, 5% and 25%, 5% and 20%, 5% and 15%, 5% and 10%, 10% and 25%, 10% and 20%, 10% and 15%, 15% and 25%, 15% and 20%, or 20% and 25% graphene by weight. In some embodiments, the nonwoven composite material 110 comprises at least 5% and less than about 25%, about 20%, about 15%, about 12%, about 10%, or about 8% by weight graphene. In some embodiments, larger amounts of graphene by weight may be used, which may further enhance the properties provided by the graphene. For example greater than 25%, greater than 30%, greater than 35%, greater than 40%, greater than 45%, greater than 50%, greater than 60%, greater than 70%, greater than 80%, or greater than 90%. Such larger amounts of graphene may find particular application, for example, to fabricate darker color fabrics. All or a portion of the remaining weight may be provided by the polymer component 130. In various embodiments, the nonwoven composite material 110 of the layered composition 160 may comprise at least about 20%, about 30%, about 40%, about 50%, about 55%, about 60%, about 65%, about 70%, about 75%, about 80%, about 85%, about 90%, about 95%, or about 99% polymer component 130 by weight. The polymer component 130 may be selected from thermoplastics, thermoset polymers, synthetic resins, polyolefins, blends comprising at least two polyolefins, a blend comprising a polyolefin and at least one nonpolyolefin, or combinations thereof. In one embodiment, the polymer component comprises an epoxy resin, a polyolefin, or combinations thereof. In at least one embodiment, the binding resin comprises at least one thermoplastic selected from a polyvinyl chloride, polypropylene, polyethylene, polyactic acid, polyamide, polybenzimidazole, or combinations thereof.

Referring to FIG. 4, in one embodiment, the layered composition 160 includes a first layer comprising a nonwoven fabric 150 that includes all or a portion of the nonwoven composite material 110. A second layer may be attached, e.g., laminated, to the first layer. The second layer may similarly comprise a nonwoven fabric 150. For example, the nonwoven fabric 150 of the second layer may comprise a thermoset polymer, epoxy, resin, thermoplastic, polyolefin, for example, or may be selected from a polyvinyl chloride, polypropylene, polyethylene, polyactic acid, polyamide, polybenzimidazole, or combinations thereof. In one embodiment, the first layer comprises polyvinyl chloride or a blend of polyvinyl chloride and another polyolefin. The second layer may comprise polyvinyl chloride, another polyolefin, thermoplastic, epoxy, or combination thereof.

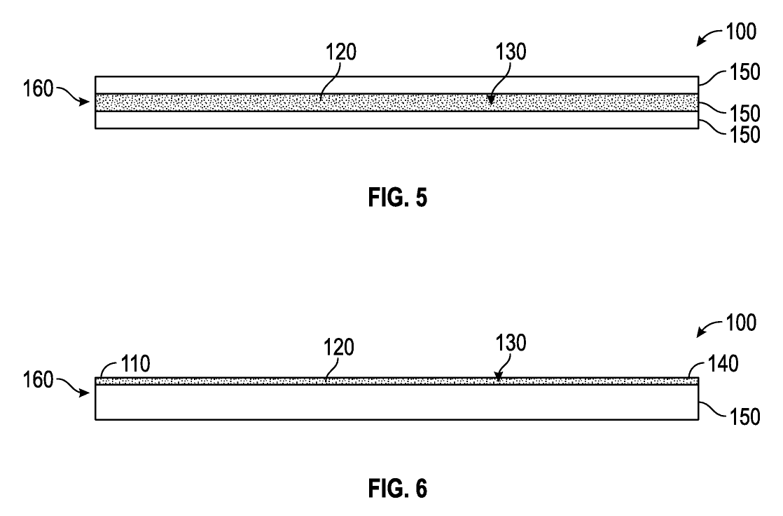

FIG. 5 illustrates a further embodiment wherein the layered composition 160 comprises a third, outer, layer attached, e.g., laminated, to the first layer. In this configuration, the third layer comprises a nonwoven fabric 150. For example, the nonwoven fabric 150 of the third layer may comprise a thermoset polymer, epoxy, resin, thermoplastic, polyolefin, for example, or may be selected from a polyvinyl chloride, polypropylene, polyethylene, polyactic acid, polyamide, polybenzimidazole, or combinations thereof. In one embodiment, the third layer comprises polyvinyl chloride or a blend of polyvinyl chloride and another polyolefin. The third layer may comprise polyvinyl chloride, another polyolefin, thermoplastic, epoxy, or combination thereof. In one embodiment, one or more of the outer layers comprises the nonwoven composite material 110. In one example of the composite composition of FIG. 5, the outer layers include spunbonded polypropylene and the middle layer comprises melt-blown polypropylene. In one embodiment, all layers comprise the nonwoven composite material 110. In at least one embodiment, the nonwoven composite 110 includes a coating, as described above (see FIGS. 3A and 3B), applied to one or both of the outer layers. In such an embodiment, one, more, or none of the layers may also include the nonwoven composite material 110. In one embodiment, the nonwoven composite material 110 comprises an adhesive or binder applied between the layers to attach or laminate the layers. In such an embodiment, one, more, or none of the layers may also include the nonwoven composite material 110. One or more layers may include a coating, in addition to or instead of layers formed of the nonwoven composite material 110.

FIG. 6 illustrates and embodiment of a layered composition 160 wherein a first layer comprises a microporous film 140 and a second layer comprises nonwoven fabric 150. At least one of the first layer, second layer, or both comprise the nonwoven composite material 110. When both layers comprise the nonwoven composite material 110, the polymer component 130 of the first and second layers may be the same or different. Additionally, the percent composition by weight of graphene component 120 to polymer component 130 in the first and second layers may be the same or different. In a further example, the first layer comprises spunbonded polypropylene and the second layer comprises microporous polyethylene film. At least one of the first layer, second layer, or both comprise the nonwoven composite material 110. Thus, the polymer component 130 may comprise polypropylene, polyethylene, or both. The spunbonded polypropylene may be thermally bonded or bonded with a resin. In one embodiment, all or a portion of the graphene component 120 may be within the resin, which may include a portion of the polymer component 130. In one application of the layered composition 160, the spunbonded polypropylene, which may include the graphene component 120, may be incorporated into an article as an inner layer and the microporous film 140 comprising a microporous polyethylene film, which may include the graphene component 120, may be incorporated as an outer layer. The outer layer of microporous film 140 may provide a breathable fabric with antidust, antibacterial, liquid impervious, and fire retardant properties. In further examples, the layered composition 160 may include additional layers. In one embodiment, all layers comprise the nonwoven composite material 110. In at least one embodiment, the nonwoven composite material 110 or microporous film includes a coating (see FIGS. 3A and 3B) applied to one or both of the layers. In such an embodiment, one, both, or none of the layers may also include the nonwoven composite material 110. In one embodiment, the nonwoven composite material 110 comprises an adhesive or binder applied between the layers to attach or laminate the layers. In such an embodiment, one, both, or none of the layers may also include the nonwoven composite material 110. One or more layers may include a coating, in addition to or instead of layers formed of the nonwoven composite material 110.

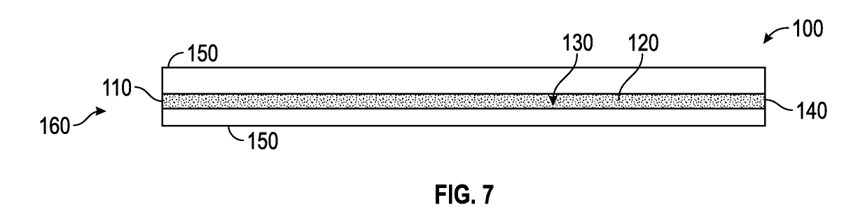

In various embodiments, the layered composition 160 comprises at least three layers, wherein at least one of the layers comprises a nonwoven composite material 110 including the graphene component 120 and the polymer component 130 (e.g., FIGS. 5 and 7). The polymer component 130 may be a polyolefin, for example, or may be selected from a polyvinyl chloride, polypropylene, polyethylene, polyactic acid, polyamide, polybenzimidazole, or combinations thereof. When multiple layers comprise the nonwoven composite material 110, the polymer component 130 within each of the layers may be the same or different. Additionally, the percent composition by weight of graphene component 120 to polymer component 130 in each of the layers may be the same or different.

FIG. 7 illustrates one embodiment of the layered composition 160 including at least three layers. In particular, the layered composition 160 comprises a middle film layer, e.g., microporous film 140, and two outer nonwoven fabric layers 150, wherein at least one of the layers comprises all or a portion of the nonwoven composite composition 110. While various configurations may be used, the illustrated layered composition 160 includes a first layer of spunbonded polypropylene, a second, middle, layer of microporous polyethylene film and a third layer of spunbonded polypropylene. Thus, the polymer component 130 may comprise polypropylene, polyethylene, or both. As shown, the middle layer includes the nonwoven composite material 110 in the form of a microporous polyethylene film wherein the polymer component comprise polyethylene. In other embodiments, the spunbonded polypropylene may be thermally bonded or bonded with a resin wherein all or a portion of the graphene component 120 may be within the resin, which may include a portion of the polymer component 130. In one application of the layered composition 160, the layered composition 160 may be incorporated into an article, such as a garment, to provide a microporous garment providing a wearer of the garment with basic protection and comfort. The microporous garment having the graphene additive may include properties such as antidust, antibacterial, and fire retardant. The microporous garment may have high strength, may provide an impervious barrier to particulates or liquids, and may be resistant to tears and punctures. A mean pore size of a microporous multilayer composition of spunbonded polypropylene and microporous polyethylene film may vary with a layer arrangement. Adjustments to the layer arrangement of composite films may make layered microporous films 140 with controlled properties. For example, a layered composite microporous film 140 may be arranged to provide a garment with air and moisture permeation through an impervious barrier, which may be fire retardant, structurally rigid, tear resistant, soft and comfortable.

As introduced above, the nonwoven composite material 110 of the layered composition 160 may comprise an adhesive comprising the graphene component 120 and the polymer component 130, or portions thereof. The adhesive may be used to laminate layers as described herein. For example, the polymer component 130 may be in the form of a wet or dry resin suitable to bond layers. The bonded layers may include nonwoven fabrics 150, woven fabrics, films, microporous films 140, or combinations thereof. For example, any of the composite compositions 100 described above with respect to FIGS. 1-3B may be further laminated or laminate one or more additional materials to form a layered composition 160 adhered with an adhesive that includes all or a portion of the nonwoven composite material, which may be in addition to or instead of layers comprising nonwoven composite material 110. In further examples, the layered compositions 160 illustrated in FIGS. 4-7 may be adhered with an adhesive comprising all or a portion of the nonwoven composite material 110, which may be in addition to or instead of layers comprising nonwoven composite material 110. In still further examples, the composite compositions 100 illustrated in FIGS. 1-3B or the layered compositions 160 illustrated in FIGS. 4-7 may include layers laminated or finished (as described above) with all or a portion of the nonwoven composite material 110, which may be in addition to or instead of layers comprising nonwoven composite material 110.

In one embodiment, the adhesive bonds a precursor film to at least one additional layer. The precursor film, adhesive, and additional layer may be stretched, as described above with respect to the nonwoven material comprising a microporous film 140, to form micropores through at least the precursor film and the adhesive. The adhesive may include a polymer component 130 and an inorganic filler material, both of which may be similar to those described above with respect to the nonwoven composite material 110 comprising a microporous film 140. For example, the polymer component 130 may comprise one or more thermoplastics, thermoset polymers, or combinations thereof. In some embodiments, the polymer component 130 comprises at least one synthetic resin. In one example, the polymer component 130 comprises at least one polyolefin, a blend comprising at least two polyolefins, or a blend comprising a polyolefin and at least one nonpolyolefin. In one or the above or another example, the polymer component 130 comprises an epoxy resin. In one embodiment, the polymer component 130 comprises one or more thermoplastics selected from a polyvinyl chloride, polypropylene, polyethylene, polyactic acid, polyamide, polybenzimidazole, or combinations thereof. In various embodiments, the adhesive may include percent weights of graphene component 120 and polymer component 130 similar to those described above with respect to nonwoven composite materials 110 comprising coatings.

The composite composition 100 may include composites of various colors, e.g., white, orange, blue, green, red, yellow, florescent orange, florescent yellow, etc. and weight compositions. To obtain desired colors, dyes may be added during fabrication, e.g., to the melt, or after fabrication. In some embodiments, the nonwoven composite material 110 comprising a nonwoven fabric 150 is not dyed. Fabricating a composite composition 100 having desired colors may, for example, include forming a layered composition 160 wherein the nonwoven composite material 110 comprising a nonwoven fabric 150 is layered with another nonwoven or woven fabric having a desired color or color combination.

The composite composition 100 may be used in the manufacture of fabric and fabric like articles, such as garments, bedding, tarps, umbrellas, or other articles wherein barriers may be desirable, including those where breathable barriers may be desirable. For example, garments comprising the composite composition 100 may be particularly suitable for outdoor sporting events, recreational activities, and various other activities. Fire retardant properties of the composite composition 100 may deem it particularly suitable for incorporation into a breathable impervious nonwoven composite barrier fabric. The impervious nature of the composite composition 100 may prevent water based liquids and bodily fluids from penetrating the fabric. Applications for the compound composition may include those in fields using protective garments, such as, without limitation, the building/construction industry, industrial fields, laboratory personnel, medical technicians, hospital and other healthcare fields, outdoor sporting events, recreational activities, and other various events, as well as in commercial and industrial applications. In various embodiments, the composite composition 100 may be used in the manufacture of durable articles or disposable articles. For example, the composite composition 100 may be used in the manufacture of durable all-weather garments or disposable surgical garments. In some embodiments, the composite composition 100 may be incorporated into a garment to therein provide rigidity, e.g., tensile strength, and liquid barrier characteristics that may allow perspiration to escape as well as retard fire from penetrating the garment. In one embodiment, the composite composition 100 may be incorporated into a hospital gown, surgical mask or gloves, bedding, scrubs, or other medical article.

This disclosure describes various elements, features, aspects, and advantages of various embodiments and examples and configurations thereof of composite compositions. It is to be understood that certain descriptions of the various embodiments have been simplified to illustrate only those elements, features and aspects that are relevant to a more clear understanding of the disclosed embodiments, while eliminating, for purposes of brevity or clarity, other elements, features and aspects. Any references to “various embodiments,” “certain embodiments,” “some embodiments,” “one example,” “one embodiment,” an “example,” or “an embodiment” generally means that a particular element, feature and/or aspect described in the embodiment is included in at least one embodiment. The phrases “in various embodiments,” “in certain embodiments,” “in some embodiments,” “in one embodiment,” or “in an embodiment” may not refer to the same embodiment.” Furthermore, the phrases “in one such embodiment” or “in certain such embodiments,” or “in one example,” while generally referring to and elaborating upon a preceding embodiment, is not intended to suggest that the elements, features, and aspects of the embodiment introduced by the phrase are limited to the preceding embodiment; rather, the phrase is provided to assist the reader in understanding the various elements, features, and aspects disclosed herein and it is to be understood that those having ordinary skill in the art will recognize that such elements, features, and aspects presented in the introduced embodiment may be applied in combination with other various combinations and sub-combinations of the elements, features, and aspects presented in the disclosed embodiments. It is to be appreciated that persons having ordinary skill in the art, upon considering the descriptions herein, will recognize that various combinations or sub-combinations of the various embodiments and other elements, features, and aspects may be desirable in particular implementations or applications. However, because such other elements, features, and aspects may be readily ascertained by persons having ordinary skill in the art upon considering the description herein, and are not necessary for a complete understanding of the disclosed embodiments, a description of such elements, features, and aspects may not be provided. As such, it is to be understood that the description set forth herein is merely exemplary and illustrative of the disclosed embodiments and is not intended to limit the scope of the invention as defined solely by the claims.

The grammatical articles “one”, “a”, “an”, and “the”, as used in this specification, are intended to include “at least one” or “one or more”, unless otherwise indicated. Thus, the articles are used in this specification to refer to one or more than one (i.e., to “at least one”) of the grammatical objects of the article. By way of example, “a component” means one or more components, and thus, possibly, more than one component is contemplated and may be employed or used in an implementation of the described embodiments. Further, the use of a singular noun includes the plural, and the use of a plural noun includes the singular, unless the context of the usage requires otherwise. Additionally, the grammatical conjunctions “and” and “or” are used herein according to their accepted usage. By way of example, “x and y” refers to “x” and “y”. On the other hand, “x or y” refers to “x”, “y”, or both “x” and “y”, whereas “either x or y” refers to exclusivity.

What is claimed is:

1. A composite composition, the composition comprising:
a nonwoven composite material, wherein the nonwoven composite material comprises a graphene component and a polymer component.

2. The composite composition of claim 1, wherein the nonwoven composite material comprises a film comprising the graphene component and the polymer component.

3. The composite composition of claim 2, wherein the film is a microporous film.

4. The composite composition of claim 3, wherein the composite composition comprises a layered composition comprising the microporous film and a nonwoven fabric, and wherein the nonwoven fabric is laminated with the microporous film.

5. The composite composition of claim 1, wherein the nonwoven composite material comprises a nonwoven fabric comprising the graphene component and the polymer component.

6. The composite composition of claim 5, wherein the graphene component and the polymer component comprise a binder.

7. The composite composition of claim 6, wherein the polymer component comprises a thermoplastic or resin.

8. The composite composition of claim 1, wherein the composite composition comprises a nonwoven fabric, and wherein the nonwoven composite material coats the nonwoven fabric.

9. The composite composition of claim 1, wherein the composite composition comprises a layered composition comprising a nonwoven fabric layer and a microporous film layer, wherein at least one of the nonwoven fabric layer or microporous film layer is coated with the nonwoven composite material.

10. The composite composition of claim 1, wherein the composite composition comprises a layered composition, wherein a first layer and a second layer of the layered composition are laminated, and wherein the nonwoven composite material comprises an adhesive between the first layer and the second layer.

11. The composite composition of claim 10, wherein the first layer comprises a nonwoven fabric layer and the second layer comprises a microporous film layer.

12. The composite composition of claim 1, wherein the composite composition comprises a layered composition, wherein the nonwoven composite material comprises a first layer.

13. The composite composition of claim 12, wherein the nonwoven composite material of the first layer comprises a microporous film and wherein the microporous film is thermally bonded to a second layer comprising a nonwoven fabric.

14. The composite composition of claim 12, wherein the nonwoven composite material of the first layer comprises a microporous film and wherein the microporous film is thermally bonded to a second layer comprising a microporous film.

15. The composite composition of claim 13, wherein the composite composition comprises a third layer, wherein the third layer is thermally bonded to one of the first or second layers, and wherein the third layer comprises a nonwoven fabric or a microporous film.

16. The composite composition of claim 14, wherein the composite composition comprises a third layer, wherein the third layer is thermally bonded to one of the first or second layers, and wherein the third layer comprises a nonwoven fabric or a microporous film.

17. The composite composition of claim 12, wherein the nonwoven composite material of the first layer comprises a nonwoven fabric, and wherein the nonwoven fabric is thermally bonded to a second layer comprising a microporous film.

18. The composite composition of claim 12, wherein the nonwoven composite material of the first layer comprises a nonwoven fabric, and wherein the nonwoven fabric is thermally bonded to a second layer comprising a nonwoven fabric.

19. The composite composition of claim 17, wherein the composite composition comprises a third layer, wherein the third layer is thermally bonded to one of the first or second layers, and wherein the third layer comprises a nonwoven fabric or a microporous film.

20. The composite composition of claim 18, wherein the composite composition comprises a third layer, wherein the third layer is thermally bonded to one of the first or second layers, and wherein the third layer comprises a nonwoven fabric or a microporous film.
